(19) United States
(12) Patent Application Publication
(10) Pub. No.: US 2026/0202064 A1
(43) Pub. Date: Jul. 16, 2026

(54) OVEN

(71) Applicant: GRAND MATE CO., LTD., Taichung City (TW)

(72) Inventors: CHIN-YING HUANG, Taichung City (TW); HSIN-MING HUANG, Taichung City (TW); HSING-HSIUNG HUANG, Taichung City (TW); YEN-JEN YEH, Taichung City (TW)

(73) Assignee: GRAND MATE CO., LTD., Taichung City (TW)

(21) Appl. No.: 19/021,074

(22) Filed: Jan. 14, 2025

(51) Int. Cl. F24C 1/16; A47J 37/01; A47J 37/06

(52) U.S. Cl. CPC F24C 1/16; A47J 37/01; A47J 37/015; A47J 37/0629; A47J 37/0647

(57) ABSTRACT

An oven includes a base, a foldable oven body, a cap and a heating device, wherein the base has an upper accommodating recess. The foldable oven body, including a plurality of wall plates, is manipulated to be transformable between an unfolded configuration and a folded configuration. A top plate of the cap concavely forms a heating recess. The heating recess is provided inside the cap and located on an opposite side of the heating recess. When the foldable oven body is in the unfolded configuration, the plurality of wall plates collectively form a baking space and are detachably inserted into the upper accommodating recess, and the top plate detachably covers a top side of the foldable oven body. At the time, the heating device faces the baking space and heat generated by the heating device heats the baking space and the heating recess simultaneously.

### BACKGROUND OF THE INVENTION

### Technical Field

The present invention relates generally to an oven, and more particularly to a foldable oven that heats both inside and outside the cap.

### Description of Related Art

A conventional oven includes an oven body and a heater, wherein a baking space is provided inside the oven body for placing food to be baked, and the heater is disposed in the oven body for heating the baking space so that the food to be baked is heated in the baking space.

Taking a household oven as an example, the oven brings convenience and fun for baking food; the shape of the oven body is fixed and occupies a considerable amount of volume because the oven body consists of several plates that are fixedly connected to each other, however. When there is a need to move the oven, a user usually has to carry the oven body, making the oven difficult to move. Additionally, when it comes to storing the oven, larger storage space is needed for the oven because the oven body takes up a significant volume.

The inconvenience of moving and storing the oven means that the oven is typically used in a fixed location in the house and is less likely to be used for outdoor camping. In addition, when removing food from the baking tray, the oven is not able to continuously heat or keep the food warm.

Therefore, the conventional design for the oven still has room for improvement.

### BRIEF SUMMARY OF THE INVENTION

In view of the above, the primary objective of the present invention is to provide an oven with a foldable oven body, which is convenient to fold the oven body for carrying and storage, along with a heating device that could heat the baking space and the top of the cap simultaneously.

The present invention provides an oven, including a base, a foldable oven body, a cap, and a heating device. The base includes a bottom plate and a plurality of side plates that are connected to the bottom plate and form an upper accommodating recess together with the bottom plate. The foldable oven body, including a plurality of wall plates, is transformable between an unfolded configuration and a folded configuration. When in the unfolded configuration, the plurality of wall plates collectively form a baking space and bottom sides of the plurality of wall plates are detachably inserted into the upper accommodating recess. The cap includes a top plate that concavely forms a heating recess, the heating recess having a recess surface. The heating device is provided inside the cap and is located on an opposite side of the recess surface of the heating recess, wherein, when the foldable oven body is in the unfolded configuration, the cap detachably covers top sides of the plurality of wall plates, and the heating device faces the baking space. Heat generated by the heating device heats the baking space and the recess surface of the heating recess.

With the aforementioned design, the heating device could heat the baking space and the recess surface of the heating recess simultaneously, not only breaking through the conventional limitations of ovens that typically confine baking to the interior of the oven, but the foldable oven body also providing greater portability and convenience for the oven because of the foldable oven body with a flexible transformation between the unfolded and folded configurations.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of an oven according to a first embodiment of the present invention;

FIG. 2 is a partially exploded perspective view of the oven according to the first embodiment of the present invention;

FIG. 3 is a back view of the oven according to the first embodiment of the present invention;

FIG. 4 is a perspective view of a cap according to the first embodiment of the present invention, illustrating the cap in an inverted position;

FIG. 5 is a perspective view of a foldable oven body and a base according to the first embodiment of the present invention;

FIG. 6 is a perspective view of the base according to the first embodiment of the present invention;

FIG. 7 is a sectional view along the 7-7 line in FIG. 3;

FIG. 8 is a sectional view along the 8-8 line in FIG. 2;

FIG. 9 is a perspective view of the oven according to the first embodiment of the present invention, illustrating a baking tray placed on the cap;

FIG. 10 is a side view of the foldable oven body according to the first embodiment of the present invention, illustrating the foldable oven body in a folded configuration;

FIG. 11 is an exploded perspective view of the oven according to the first embodiment of the present invention, illustrating the exploded perspective view of the oven in a stowed configuration;

FIG. 12 is a perspective view of the oven according to the first embodiment of the present invention, illustrating the oven in the stowed configuration;

FIG. 13 is another perspective view from below of the oven according to the first embodiment of the present invention, illustrating the oven from below when the oven is in the stowed configuration; and

FIG. 14 is a perspective view of the foldable oven body and the base according to a second embodiment of the present invention.

### DETAILED DESCRIPTION OF THE INVENTION

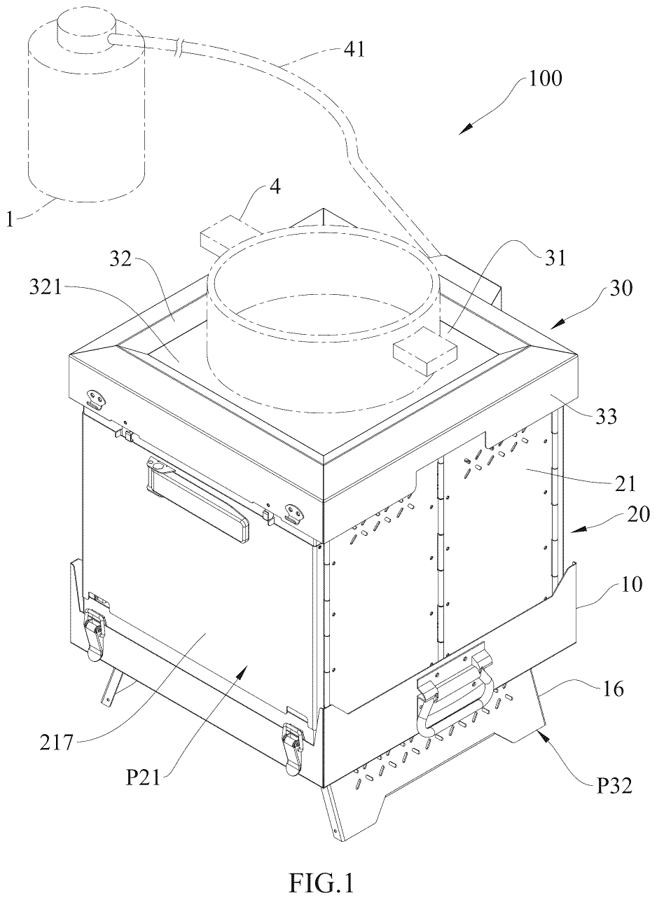

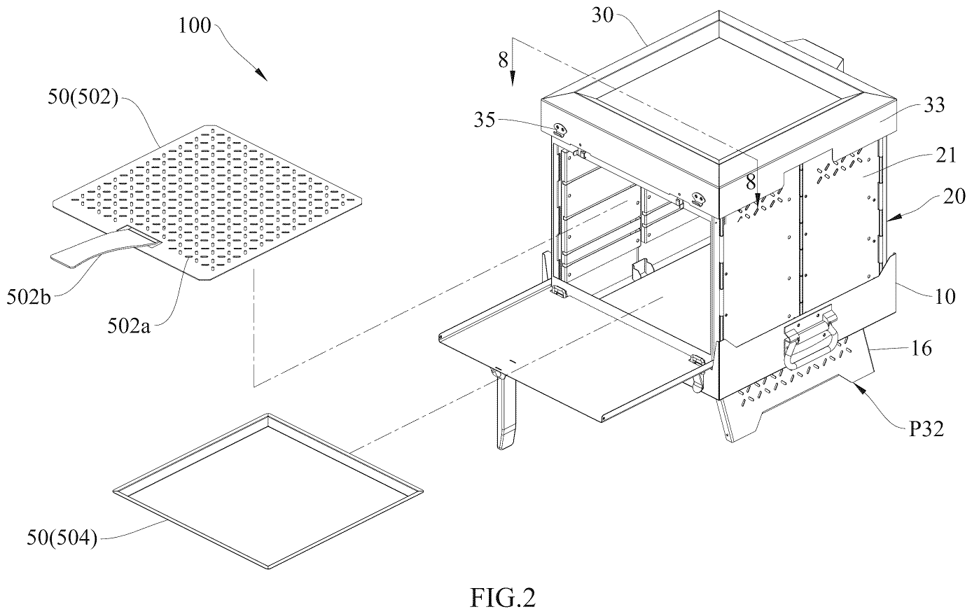

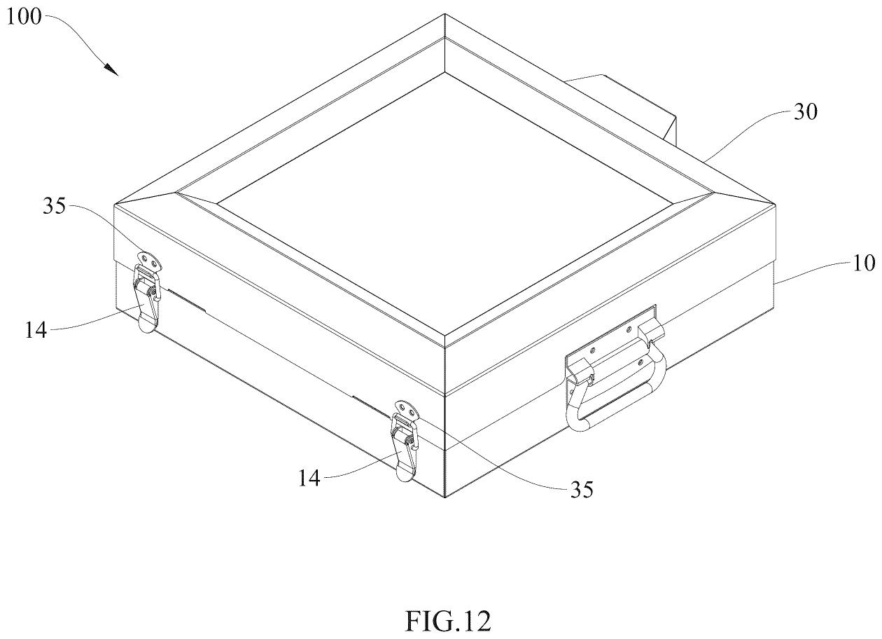

The oven 100 according to a first embodiment of the present invention is illustrated in FIG. 1 to FIG. 13, wherein the oven 100 includes a base 10, a foldable oven body 20, a cap 30, and a heating device 40. In addition, the oven 100 could further include at least one baking tray 50. In the current embodiment, the number of the at least one baking tray 50 could be plural and the plurality of baking trays 50 include a first baking tray 502 and a second baking tray 504. A tray surface of the first baking tray 502 has a plurality of mesh openings 502a. The first baking tray 502 could be detachably coupled with a handle 502b. A tray surface of the second baking tray 504 recesses downward and does not have mesh openings, which could be used to hold food and collect oil, water, or other liquids.

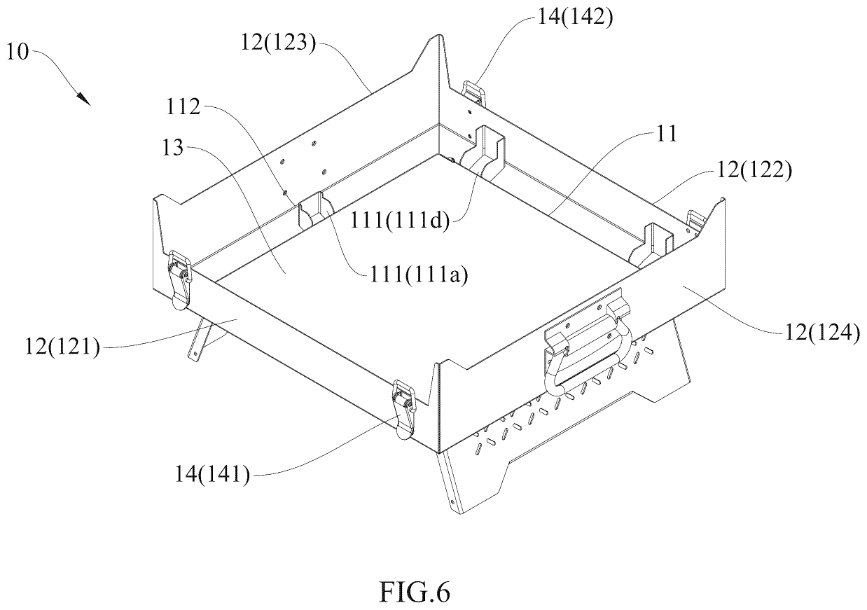

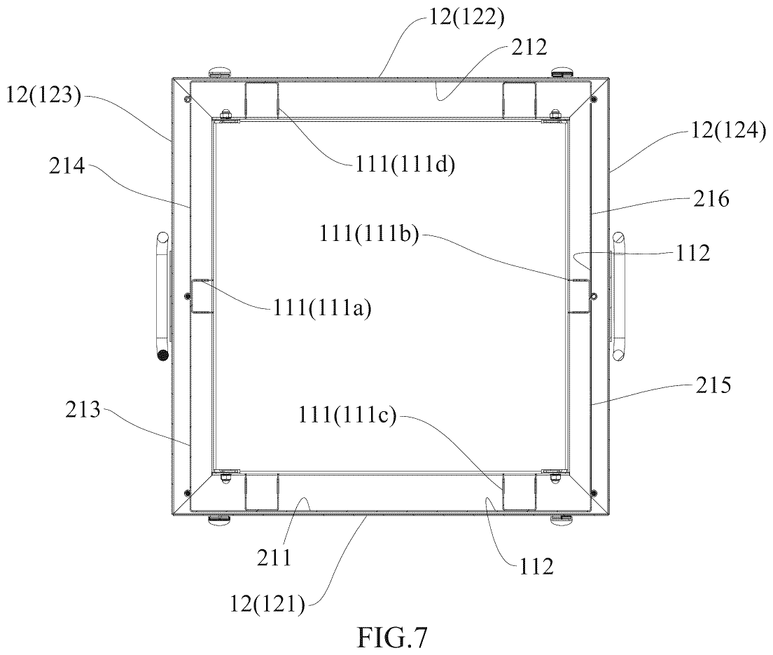

The base 10 includes a plurality of side plates 12 and a bottom plate 11. The plurality of side plates 12 are connected to the bottom plate 11 and form an upper accommodating recess 13 together with the bottom plate 11 (shown in FIG. 6 and FIG. 7). The plurality of side plates 12 of the base 10 includes a front side plate 121, a rear side plate 122, a left side plate 123, and a right side plate 124. In the current embodiment, the base 10 is made of metal. The bottom plate 11 has a plurality of fixed seats 111 that are adjacent to each of the side plates 12, a gap 112 forming between each of the fixed seats 111 and each of the side plates 12. In the current embodiment, the plurality of fixed seats 111 of the base 10 include two front fixed seats 111c, two rear fixed seats 111d, a left fixed seat 111a, and a right fixed seat 111b. In an embodiment, the number of the front fixed seat 111c and the rear fixed seat 111d could be one for each.

The base 10 further has a plurality of latches 14 that include at least one front latch 141 and at least one rear latch 142. In the current embodiment, the numbers of the front latch 141 and the rear latch 142 are two for each as an example, but not limited thereto. The two front latches 141 are disposed on the front side plate 121 while the two rear latches 142 are disposed on the rear side plate 122.

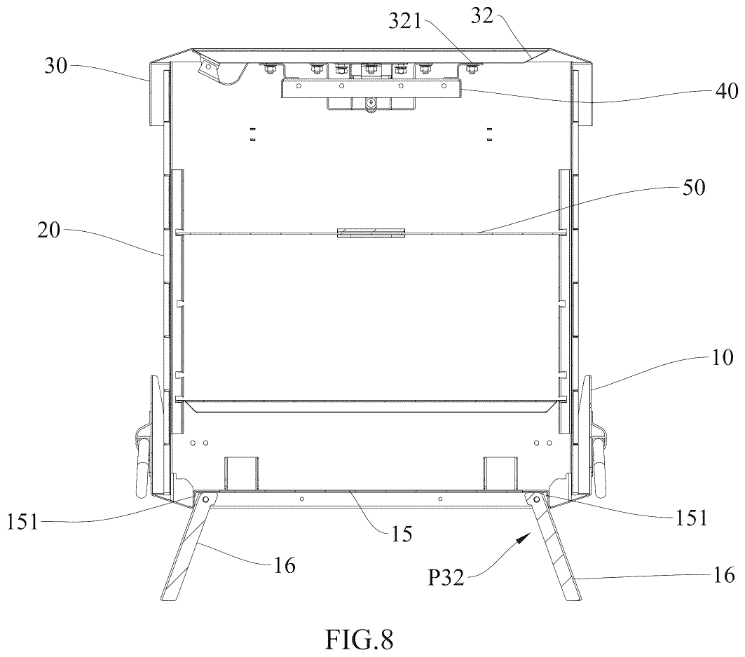

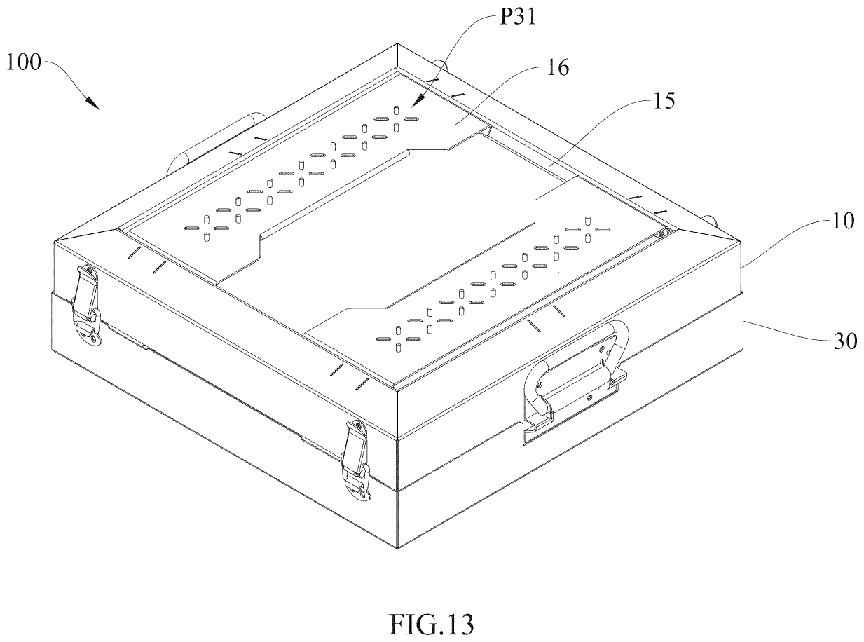

As shown in FIG. 6, FIG. 8, and FIG. 13, a bottom of the bottom plate 11 has a lower accommodating recess 15. Two stands 16, pivotably disposed at the lower accommodating recess 15, could be pivotable between a first position P31 as shown in FIG. 8 and a second position P32 as shown in FIG. 13. When the two stands 16 are pivoted to the first position P31, a portion of the two stands 16 is located outside the lower accommodating recess 15, and the two stands 16 respectively abut against two recess walls 151, which are opposite to each other, of the lower accommodating recess 15, making the two stands 16 relatively spread apart. When the two stands 16 are pivoted to the second position P32, the two stands 16 are folded flat and are retracted into the lower accommodating recess 15.

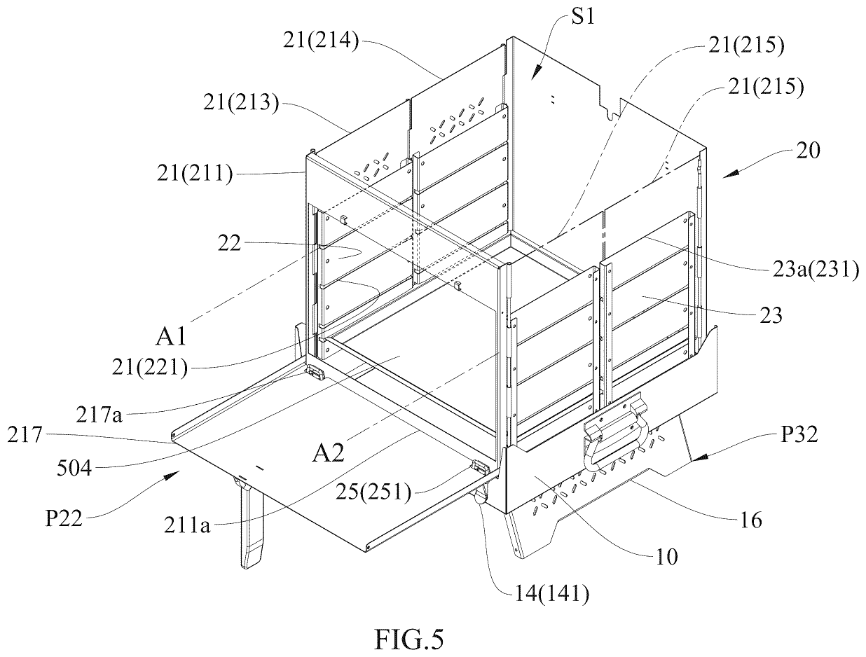

As shown in FIG. 5 to FIG. 7, the foldable oven body 20 has a plurality of wall plates 21 that include a front wall plate 211, a rear wall plate 212, a first left side wall plate 213, a second left side wall plate 214, a first right side wall plate 215, and a second right side wall plate 216. Two ends of the front wall plate 211 are respectively hinged to the first left side wall plate 213 and the first right side wall plate 215, and two ends of the rear wall plate 212 are respectively hinged to the second left side wall plate 214 and the second right side wall plate 216. An inner surface of the first left side wall plate 213 and an inner surface of the second left side wall plate 214 are respectively provided with a left support, and an inner surface of the first right side wall plate 215 and an inner surface of the second right side wall plate 216 are respectively provided with a right support 23, wherein each left support 22 has at least one left support portion 22a and each right support 23 has at least one right support portion 23a. In the current embodiment, the foldable oven body 20 is made of metal. In the current embodiment, the number of the left support portion 22a of each left support 22 could be plural, and each left support portion 22a is a left guide slot 221, while the number of the right support portion 23a of each right support 23 could be plural and each right support portion 23a is a right guide slot 231.

When the foldable oven body 20 is in the unfolded configuration, the plurality of wall plates 21 collectively form a baking space S1, and bottom sides of the plurality of wall plates 21 are detachably inserted into the plurality of gaps of the base 10. The left fixed seat 111a abuts against a hinge point between the first left side wall plate 213 and the second left side wall plate 214, and the right fixed seat 111b abuts against a hinge point between the first right side wall plate 215 and the second right side wall plate 216. At the time, the corresponding two left support portions 22a both extend along a first axis A1, and the corresponding two right support portions 23a both extend along a second axis A2, the first axis A1 being parallel to the second axis A2.

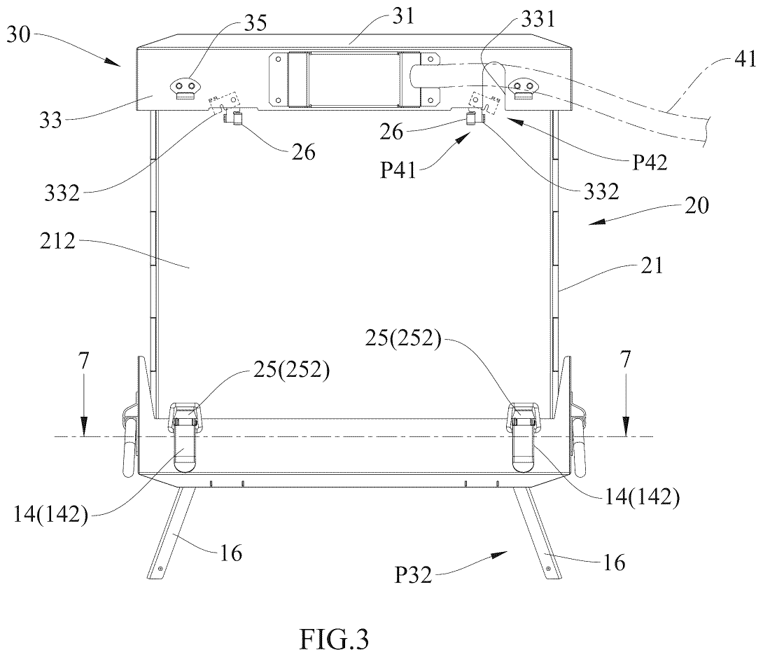

In addition, as shown in FIG. 3, FIG. 5, and FIG. 6, the foldable oven body 20 is provided with a plurality of second catch plates 25 that respectively correspond to the plurality of latches 14. The second catch plate 25 includes at least one front catch plate 251 and at least one rear catch plate 252, the number of which are two front catch plates 251 and two rear catch plates 252 as an example in the current embodiment, but not limited thereto. The two front catch plates 251 are mounted on the rear wall plate 211, and the two rear catch plates 252 are mounted on the rear wall plate 212. When the foldable oven body 20 is in the unfolded configuration, the foldable oven body 20 is able to be provided on the upper accommodating recess 13 of the base 10, each latch 14 is detachably fastened to each corresponding second catch plate 25, that is, each front latch 141 is fastened to each corresponding front catch plate 251, and each rear latch 142 is fastened to each corresponding rear catch plate 252, allowing the foldable oven 20 to be more securely positioned on the base 10.

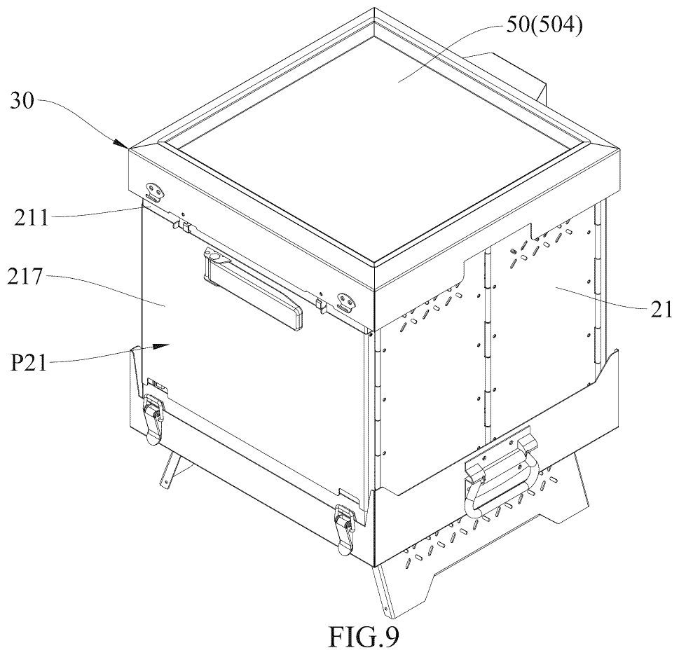

As shown in FIG. 5 and FIG. 9, the front wall plate 211 has an entrance 211a corresponding to the two left guide slots 221 and the two right guide slots 231, and the front catch plate 251 is located below the entrance 211a. A door 217 is pivotably disposed on the front wall plate 211, with at least one clearance cutout 217a at a bottom of the door 217; in the current embodiment, the number of the clearance cutout 217a is two. The door 217 could be pivotable between a closed position P21 and an open position P22. When the door 217 is pivoted to the closed position P21, the door 217 closes the entrance 211a and abuts against the front wall plate 211. When the door 217 is pivoted to the open position P22, the door 217 opens the entrance 211a and each clearance cutout 217a surrounds each front catch plate 251. When the door 217 is pivoted to the open position P22, two sides of the first baking tray 502 pass through the entrance 211a and are respectively inserted in the left guide slots 221 of the two left support portions 22a and the right guide slots 231 of the two right supports 23a along the first axis A1 and the second axis A2. The two sides of the second baking tray 504 could be inserted in another set of the two left guide slots 221 and the two right guide slots 231.

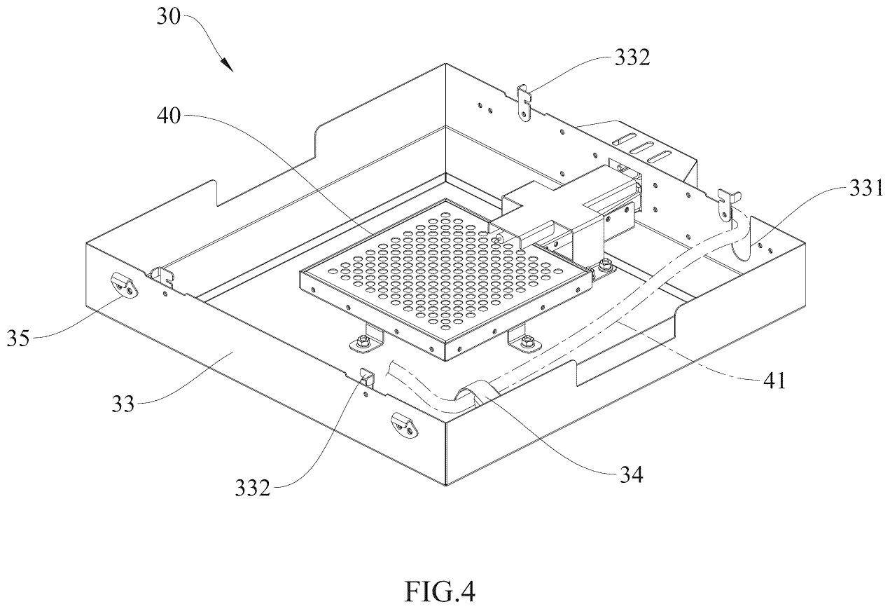

As shown in FIG. 1, FIG. 3, and FIG. 4, the cap 30 includes a top plate 31 and a surrounding wall 33. The top plate 31 concavely forms a heating recess 32 that has a recess surface 321. The surrounding wall 33 is connected to the top plate 31 and has a notch 331. When the cap 30 covers top sides of the plurality of wall plates 21 of the foldable oven body 20, one of the wall plates 21 closes the notch 331. A fixed hook 34 is provided inside the cap 30, the fixed hook 34 being located on an opposite side of the recess surface 321 of the heating recess 32. In the current embodiment, the cap 30 is made of metal.

In addition, the surrounding wall 33 of the cap 30 is pivotably provided with a plurality of fasteners 332, and the foldable oven body 20 is provided with a plurality of fixed rings 26 disposed on the front wall plate 211 and the rear wall plate 212. When the foldable oven body 20 is in the unfolded configuration and the cap 30 covers the top sides of the plurality of wall plates 21, each fastener 332 could be pivotable between a fastened position P41 and a released position P42. When each fastener 332 is pivoted to the fastened position P41, each fastener 332 is fastened to each corresponding fixed ring 26. When each fastener 332 is pivoted to the released position P42, each fastener 332 is detached from each corresponding fixed ring 26. The surrounding wall 33 of the cap 30 is further provided with a plurality of first catch plates 35 respectively corresponding to the plurality of second catch plates 25 on the foldable oven body 20.

The heating device 40, provided inside the cap 30 and located on the opposite side of the recess surface 321 of the heating recess 32, is connected to a flexible hose 41 that extends outside the surrounding wall 33. In the current embodiment, the heating device 40 is a gas burner, the flexible hose 41 is a gas hose that is connected to a gas canister 1. In an embodiment, the heating device 40 could also be an electric heater. When the cap 30 is detached from the top sides of the plurality of wall plates 21 of the foldable oven body 20, the flexible hose 41 could pass through the notch 331 and is stored inside the cap 30, with the fixed hook 34 securing the flexible hose 41.

As shown in FIG. 1, FIG. 8, and FIG. 9, when the cap 30 detachably covers the top sides of the plurality of wall plates 21 of the foldable oven body 20, the heating device 40 faces the baking space S1. The heat generated by the heating device 40 heats the baking space S1 and the recess surface 321 of the heating recess 32, for example, the heating device 40 burns gas to produce a flame that heats the recess surface 321 of the heating recess 32 on the top plate 31 upward, while the heat generated by the flame simultaneously heats the baking space S1 downward. In this manner, a cooking pot 4 could be placed on the recess surface 321 for heating. Alternatively, the baking tray 50, such as the second baking tray 504, could be placed on the heating recess 32 so that the second baking tray 504 could abut against a periphery of the heating recess 32, with a gap between the second baking tray 504 and the recess surface 321. Part of the heat generated by the heating device 40 is transferred to the second baking tray 504 through the heating recess 32, and the food on the second baking tray 504 is thereby heated or kept warm. In an embodiment, a container placed on the heating recess 32 is not limited to the baking tray 50 or the cooking pot 4, but could also be a plate, a box, or a bowl that could be heated and hold food.

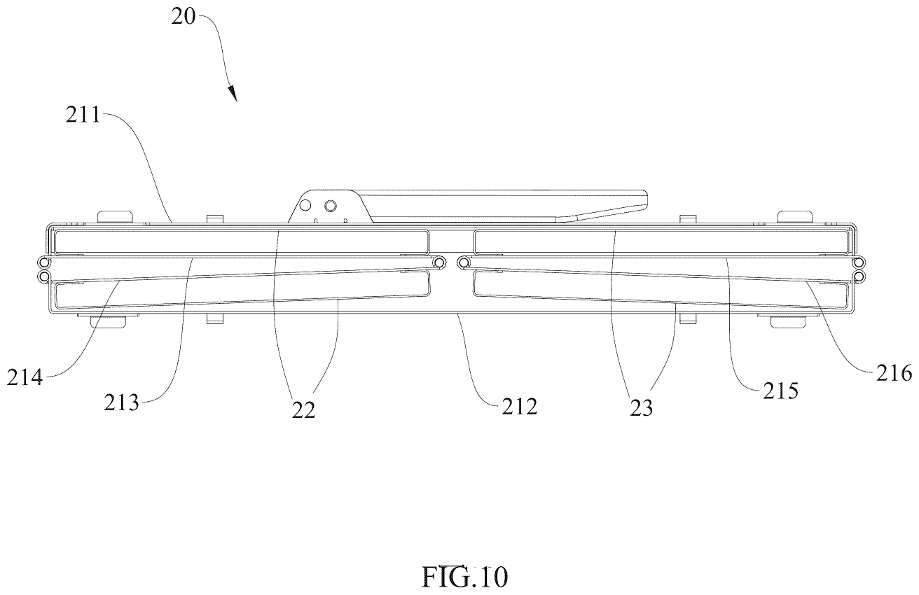

As shown in FIG. 10, the foldable oven body 20 could be manipulated to transform to a folded configuration. When the foldable oven body 20 is in the folded configuration, an outer surface of the first left side wall plate 213 and an outer surface of the second left side wall plate 214 face each other, the inner surface of the first left side wall plate 213 faces the front wall plate 211 and one of the two left supports 22 is located between the first left side wall plate 213 and the front wall plate 211, and the inner surface of the second left side wall plate 214 faces the rear wall plate 212 and the other left support 22 is located between the second left side wall plate 214 and the rear wall plate 212. An outer surface of the first right side wall plate 215 and an outer surface of the second right side wall plate 216 face each other, the inner surface of the first right side wall plate 215 faces the front wall plate 211 and one of the two right supports 23 is located between the first right side wall plate 215 and the front wall plate 211, and the inner surface of the second right side wall plate 216 faces the rear wall plate 212 and the other right support 23 is located between the second right side wall plate 216 and the rear wall plate 212.

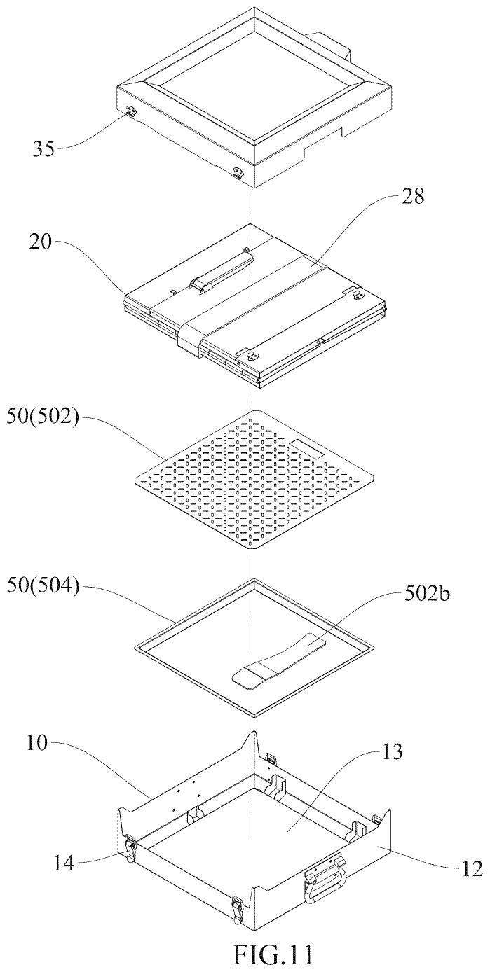

As shown in FIG. 11 to FIG. 13, when the foldable oven body 20 is in the folded configuration, the foldable oven body 20 could be secured by a binding strap 28 and be stored in the upper accommodating recess 13 of the base 10, and the cap 30 could detachably cover the plurality of side plates 12 of the base 10. In addition, the first baking tray 502, the second baking tray 504, and the handle 502b could be stored in the upper accommodating recess 13 of the base 10. When the cap 30 covers the plurality of side plates 12 of the base 10, each latch 14 of the base 10 is detachably fastened to each corresponding first catch plate 35, and the two stands 16 are retracted into the lower accommodating recess 15, thereby effectively reducing the volume of the oven 100 in the stowed configuration.

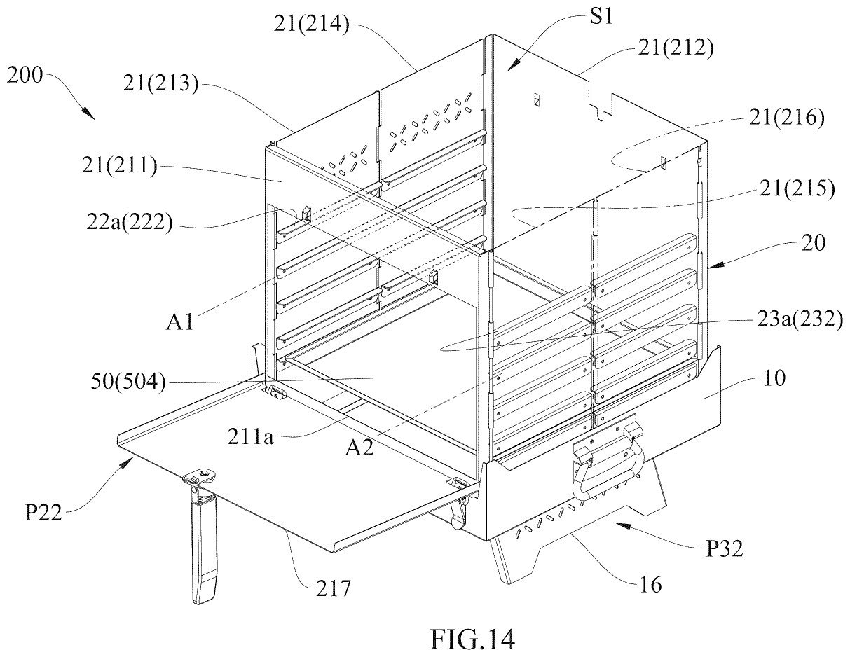

As shown in FIG. 14, an oven 200 according to a second embodiment of the present invention are almost the same as that of the first embodiment, except that:
Each left support portion 22a is a left support plate 222 and each right support portion 23a is a right support plate 232. When the foldable oven body 20 is in the unfolded configuration, the corresponding two left support plates 222 both extend along the first axis A1, the corresponding two right support plates 232 both extend along the second axis A2, and the first axis A1 is parallel to the second axis A2. When the door 217 is pivoted to the open position P22, the two sides of the first baking tray 502 pass through the entrance 211a and are respectively placed on the left support plates 222 of the two left support portions 22a and the right support plates 232 of the two right supports 23a along the first axis A1 and the second axis A2. The two sides of the second baking tray 504 could be placed on another set of the two left support plates 222 and the two right support plates 232. In the current embodiment, the design of the left support plates 222 and the right support plates 232 allows for easy insertion of the baking tray 50 into the baking space S1 and ensures a stable placement on the support plates. The support plates provide a greater contact surface to effectively distribute the load, reducing the deformation risk of the support plates under high temperature and heavy load during high-temperature use of the oven 200.

With the aforementioned design, the heating device 40 could heat the baking space S1 and the recess surface 321 of the heating recess 32 simultaneously, not only breaking through the conventional limitations of ovens that typically confine baking to the interior of the oven, but the foldable oven body 20 also providing greater portability and convenience for the oven 100, 200 because of the foldable oven body 20 with a flexible transformation between the unfolded and folded configurations.

It must be pointed out that the embodiments described above are only some preferred embodiments of the present invention. All equivalent structures which employ the concepts disclosed in this specification and the appended claims should fall within the scope of the present invention.

What is claimed is:

1. An oven, comprising:
a base, including a bottom plate and a plurality of side plates that are connected to the bottom plate and form an upper accommodating recess together with the bottom plate;
a foldable oven body, including a plurality of wall plates, the foldable oven body being manipulated to be transformable between an unfolded configuration and a folded configuration, when in the unfolded configuration, the plurality of wall plates collectively forming a baking space and bottom sides of the plurality of wall plates being detachably inserted into the upper accommodating recess;
a cap, including a top plate that concavely forms a heating recess, the heating recess having a recess surface;
a heating device, provided inside the cap and located on an opposite side of the recess surface of the heating recess;
wherein, when the foldable oven body is in the unfolded configuration, the cap detachably covers top sides of the plurality of wall plates, and the heating device faces the baking space; heat generated by the heating device heats the baking space and the recess surface of the heating recess.

2. The oven as claimed in claim 1, wherein the base includes a plurality of fixed seats that are mounted on the bottom plate and are adjacent to each of the side plates; a gap forms between each of the fixed seats and each of the side plates; when the foldable oven body is in the unfolded configuration, the bottom sides of the plurality of wall plates are inserted into the plurality of gaps.

3. The oven as claimed in claim 2, wherein the plurality of wall plates of the foldable oven body include a front wall plate, a rear wall plate, a first left side wall plate, a second left side wall plate, a first right side wall plate, and a second right side wall plate; two ends of the front wall plate are respectively hinged to the first left side wall plate and the first right side wall plate, two ends of the rear wall plate are respectively hinged to the second left side wall plate and the second right side wall plate, the first left side wall plate is hinged to the second left side wall plate, and the first right side wall plate is hinged to the second right side wall plate; the plurality of fixed seats include a left fixed seat and a right fixed seat; when the bottom sides of the plurality of wall plates are inserted into the plurality of gaps, the left fixed seat abuts against a hinge point between the first left side wall plate and the second left side wall plate, and the right fixed seat abuts against a hinge point between the first right side wall plate and the second right side wall plate.

4. The oven as claimed in claim 3, wherein the foldable oven body includes two left supports and two right supports; the two left supports are respectively disposed on an inner surface of the first left side wall plate and an inner surface of the second left side wall plate respectively; the two right supports are respectively disposed on an inner surface of the first right side wall plate and an inner surface of the second right side wall plate respectively; each left support has a left support portion and each right support has a right support portion; when the foldable oven body is in the unfolded configuration and the bottom sides of the plurality of wall plates are inserted into the plurality of gaps, the two left support portions extend along a first axis, the two right support portions extend along a second axis, and the first axis is parallel to the second axis; the front wall plate has an entrance corresponding to the two left support portions and the two right support portions; a baking tray has two sides passing through the entrance to be respectively placed on the two left support portions and the two right support portions.

5. The oven as claimed in claim 4, wherein each left support portion is a left guide slot and each right support portion is a right guide slot; when the foldable oven body is in the unfolded configuration and the bottom sides of the plurality of wall plates are inserted into the plurality of gaps, the two left guide slots extend along the first axis, the two right guide slots extend along the second axis, and the two sides of the baking tray are respectively inserted in the two left guide slots and the two right guide slots along the first axis and the second axis.

6. The oven as claimed in claim 4, wherein each left support portion is a left support plate and each right support portion is a right support plate; when the foldable oven body is in the unfolded configuration and the bottom sides of the plurality of wall plates are inserted into the plurality of gaps, the two left support plates extend along the first axis, the two right support plates extend along the second axis, and the two sides of the baking tray are respectively placed on the two left support plates and the two right support plates along the first axis and the second axis.

7. The oven as claimed in claim 4, wherein, when the foldable oven body is in the folded configuration, an outer surface of the first left side wall plate and an outer surface of the second left side wall plate face each other, the inner surface of the first left side wall plate faces the front wall plate and one of the two left supports is located between the first left side wall plate and the front wall plate, and the inner surface of the second left side wall plate faces the rear wall plate and the other left support is located between the second left side wall plate and the rear wall plate; an outer surface of the first right side wall plate and an outer surface of the second right side wall plate face each other, the inner surface of the first right side wall plate faces the front wall plate and one of the two right supports is located between the first right side wall plate and the front wall plate, and the inner surface of the second right side wall plate faces the rear wall plate and the other right support is located between the second right side wall plate and the rear wall plate.

8. The oven as claimed in claim 1, wherein, when the foldable oven body is in the folded configuration, the foldable oven body is able to be stored in the upper accommodating recess of the base and the cap detachably covers the plurality of side plates of the base.

9. The oven as claimed in claim 8, including a plurality of latches mounted on the base, a plurality of first catch plates mounted on the cap, and a plurality of second catch plate mounted on the foldable oven body, wherein, when the cap covers the plurality of side plates of the base, each latch is detachably fastened to each corresponding first catch plate; when the foldable oven body is in the unfolded configuration and the bottom sides of the plurality of wall plates are inserted into the upper accommodating recess, each latch is detachably fastened to each corresponding second catch plate.

10. The oven as claimed in claim 9, wherein the plurality of side plates of the base includes a front side plate; the plurality of latches includes a front latch mounted on the front side plate; the plurality of wall plates of the foldable oven body includes a front wall plate having an entrance; the second catch plate includes a front catch plate mounted on the front wall plate and located below the entrance; a door is pivotably disposed on the front wall plate, with a clearance cutout at a bottom of the door; the door is pivotable between a closed position and an open position; when at the closed position, the door abuts against the front wall plate and closes the entrance; when at the open position, the door opens the entrance and the clearance cutout surrounds the front catch plate.

11. The oven as claimed in claim 1, wherein a bottom of the bottom plate of the base has a lower accommodating recess; two stands, pivotably disposed at the lower accommodating recess, are pivotable between a first position and a second position; when at the first position, a portion of the two stands is located outside the lower accommodating recess, and the two stands are relatively spread apart; when at the second position, the two stands are located inside the lower accommodating recess.

12. The oven as claimed in claim 1, wherein the cap includes a surrounding wall connected to the top plate and having a notch; when the cap covers the top sides of the plurality of wall plates, one of the wall plates closes the notch; the heating device is connected to a flexible hose that extends outside the surrounding wall; when the cap is detached from the top sides of the plurality of wall plates, the flexible hose is able to pass through the notch and is stored inside the cap.

13. The oven as claimed in claim 12, including a fixed hook provided inside the cap, wherein, when the flexible hose is stored inside the cap, the fixed hook is used to secure the flexible hose.

14. The oven as claimed in claim 1, wherein the cap includes a surrounding wall connected to the top plate; the surrounding wall is pivotably provided with a plurality of fasteners, and the foldable oven body is provided with a plurality of fixed rings; when the foldable oven body is in the unfolded configuration and the cap covers the top sides of the plurality of wall plates, each fastener is pivotable between a fastened position and a released position; when each fastener is pivoted to the fastened position, each fastener is fastened to each corresponding fixed ring; when each fastener is pivoted to the released position, each fastener is detached from each corresponding fixed ring.
